(19) United States
(12) Patent Application Publication
(10) Pub. No.: US 2011/0139037 A1
(43) Pub. Date: Jun. 16, 2011

(54) Powdery Building Compound

(75) Inventors: Uwe Holland, Fontainesleau (FR); Matthias Degenkolb, Augsburg (DE); Joachim Riedmiller, Friedberg (DE); Peter Gäberlein, Augsburg (DE); Werner Stohr, Augsburg (DE); Thomas Pfeuffer, Trostberg (DE); Christian Huber, Trostberg (DE)

(73) Assignee: CONSTRUCTION RESEARCH & TECHNOLOGY GMBH, Trostberg (DE)

(21) Appl. No.: 12/898,506

(22) Filed: Oct. 5, 2010

Related U.S. Application Data
(62) Division of application No. 10/551,742, filed on Jul. 24, 2006, now abandoned.

(30) Foreign Application Priority Data
Apr. 3, 2003 (DE) 103 15 270.9

(51) Int. Cl. C04B 16/04

(52) U.S. Cl. 106/805; 106/810; 106/804

(57) ABSTRACT

A delayed action powdery building compound is provided, consisting of a reactive support material and a liquid polymer component applied to the support material. The inventive compound can contain the support material in the form of hydraulic (latent) binder, inorganic additives and/or organic components, and the polymer component for example in the form of polyvinyl alcohols, polyvinyl acetates and MPS-based polymers. The component makes it possible to obtain the delayed liberation of the support material in an aqueous building chemical mixture as a result of a time-depending separation of the polymer component from said support material. The powdery building compound also makes it possible to carry out a time-controlled hardening of hydratable building material mixtures and to obtain a time-controlled internal drying of aqueous dispersion-based materials.

### CROSS-REFERENCE TO RELATED APPLICATION

This application is a divisional of U.S. application Ser. No. 10/551,742, filed Sep. 30, 2005, which is a national phase application of International Application No. PCT/EP2004/003519, filed Apr. 2, 2004, designating the United States and claiming priority to German Patent Application No. 103 15 270.9, filed Apr. 3, 2003, which are incorporated by reference in their entirety.

### DESCRIPTION

The present invention relates to a pulverulent building material composition having a delayed action.

At present building chemical products which enable the processor to achieve very quick building progress are becoming increasingly important. A person skilled in the art will know, in particular, systems which set appropriately quickly and whose properties in terms of setting behavior and strength development are determined by the ratio of Portland cement and high-alumina cement (K. Krenkler, Chemie des Bauwesens, vol. 1, p. 178).

To counter the shrinkage of such formulations, an experienced formulator can use further sulfate-introducing compounds in addition to the sulfate carrier already present in the Portland cement, which serves primarily to control the setting of the Portland cement. These further sulfate-introducing compounds serve, as a result of their temperature-dependent solubility, to form expansive Afm/Aft phases which are rich in water of crystallization and they counter the shrinkage of the corresponding formulation in the plastic state. With skilled selection of the components and the amounts used, the sulfate-introducing compounds can additionally ensure rapid readiness of the substrate for coating with vapor-impermeable coatings as the result of “crystalline water binding”.

It is also generally known that the high demands made of the building materials used make it necessary to employ numerous additives such as fluidizers, redispersible powders, etc. Furthermore, the required processing properties of such rapid-setting systems of the prior art can generally be achieved only by the combined use of accelerating and retarding additives such as Li₂CO₃, Ca(OH)₂, tartaric acid, citric acid, etc.

Owing to the complex and still not yet fully understood interaction of the individual components in these extremely complicated formulations, these products are generally referred to as “adjustment products”, i.e. the formulation has to be adjusted for the particular raw materials available at the time at the beginning of each individual production campaign.

Owing to the complexity of the building chemical products described, which is still regarded as a disadvantage, the problem underlying the present invention is to provide a pulverulent building material composition having a delayed action which, in terms of its processability and the use of complex control additives, provides an alternative and simple possibility for setting the processing time.

This problem has been solved by means of a corresponding building material composition which comprises
a) a reactive support material and
b) a liquid polymer compound applied to the support material.

In the case of this composition, it has surprisingly been found that a processing time which is sufficiently long for the user can be set in, for example, Portland cement/high-alumina cement mixtures by the delayed setting-free of the accelerating high-alumina cement component even without the previously required addition of appropriate retarders. At the same time, the now delayed action of the reactive support material acting as accelerating component on mixing the preparation with water makes it possible to achieve a processing profile as is usual for a normally setting system based on Portland cement. A consistency which is stable over time is found, and incipient stiffening is not observed. In addition, rapid solidification and rapid strength development corresponding to a rapid-setting Portland cement/high-alumina cement system is observed after the setting-free of the accelerating component. Completely surprisingly, it has also been found that, compared to a conventionally formulated system in which hydration of the Portland cement component and of the high-alumina cement component commence simultaneously, the building material composition of the invention reacts analogously to a Portland cement system to which the appropriate amount of high-alumina cement has been available straight away at time t₀. This is presumably attributable to the prehydration of the Portland cement and the concomitant reaction of the high-alumina cement which is made possible only later at time tₓ.

For the purposes of the present invention, a support material comprising a (latently) hydraulic binder selected from the group consisting of Portland cement, ground Portland cement clinkers, high-alumina cements, calcium sulfoaluminates, sodium aluminate, CaSO₄×nH₂O (where n=0-1.5) and CaO has been found to be particularly useful as component a). Preference is given to high-alumina cements. However, a support material which is an inorganic additive selected from the group consisting of CaSO₄×2H₂O, aluminum compounds such as Al(OH)₃, Al₂(SO₄)₃ and aluminum powder, Ca(NO₃)₂, Ca(NO₂)₂ and peroxides is equally well suited. The invention also encompasses organic compounds selected from the group consisting of calcium formate, tartaric acids and their (mixed) salts and citric acid and its (mixed) salts, triethanolamine hydrochloride, tris(hydroxymethyl)aminomethane and hydrazides as support material.

Thus, a wide range of components which can be set free in a delayed fashion and are able to participate in the development of the macroscopic properties of the end products are suitable as reactive support materials.

With regard to the polymer compound present as component b) in the composition of the invention, the invention preferably provides at least one representative of the group of polyvinyl alcohols, polyvinyl acetates, polymers based on AMPS, (un)modified biopolymers such as xanthans, carrageenins, cellulose ethers and starch ethers, silanes, polyethylene glycols and waxes.

Building material compositions comprising a support material having a mean particle size of from 0.001 μm to 1 cm, in particular from 0.01 μm to 1 mm, have been found to be particularly advantageous.

Apart from the pulverulent composition, the present invention also encompasses the use thereof, specifically for, firstly, controlled curing over time of hydratable building material mixtures and, secondly, for controlled “internal drying” over time of building materials based on aqueous dispersions.

In the two alternative uses claimed, the controlled curing should, according to the invention, preferably occur as a result of detachment of the polymer compound from the support material, in particular by means of mechanical action and/or the action of a solvent, with water being particularly preferred as solvent in the latter case.

A further preferred use variant provides for the detachment being aided by addition of an activator before, during and/or after mixing of the building material mixture with water, with at least one representative of the group of borates being then used as activator, preferably in amounts of from 0.01 to 50% by weight, based on the amount of support material. According to the invention, the activator can be added either in liquid form or as a powder or as a liquid immobilized on a support material.

Finally, the present invention further provides a specific use of the pulverulent composition in building material mixtures comprising binders, preferably in the form of Portland cement, ground Portland cement clinkers, high-alumina cements, lime, CaSO₄ in different and adjustable stages of hydration, water glass, (activatable) slags such as slag sands and fly ashes, calcium sulfoaluminates and/or phosphate cements, and also aggregates and additives.

In summary, the use of the pulverulent building material composition claimed in each case follows the principle that coating of individual or a plurality of reactive components with suitable coating materials which become detached from the coated components during the course of mixing the aqueous preparation and set the coated components free in their original active form with a time delay after the first addition of water to the dry preparation enables a delayed setting-free of components over time to be set in a preparation which cures after addition of water. The setting-free of the coated component can be achieved either by means of mechanical abrasion during mixing with water, by slow dissolution in water or additionally by the addition of a suitable activator.

According to the invention, a reactive support material which preferably has a setting action and particularly preferably is a hydraulic or latently hydraulic binder which develops its setting action in the presence of water is made available.

A liquid polymer compound is applied to this reactive support material. This liquid polymer compound initially covers the support material so that the latter is at the beginning not available for the setting reaction. The ratio of liquid polymer compound to support material is preferably set so that the support material particles are completely enveloped by the polymer compound. The setting-free of the reactive support material occurs in a delayed fashion, e.g. by means of mechanical removal of the polymer shell or dissolution of the polymer shell in a solvent, e.g. water. After setting-free, the reactive support material can then, in a delayed fashion, participate in the setting reaction.

The invention thus relates to a pulverulent building material composition which has a delayed action and comprises a reactive support material and a liquid polymer compound applied to the support material. This composition, which can comprise preferably (latently) hydraulic binders as support material, inorganic additives and/or organic compounds and also, as polymer compound, for example, polyvinyl alcohols, polyvinyl acetates and polymers based on AMPS, makes it possible to achieve time-delayed setting-free of the support material in the building chemical mixture which has been made up with water as a result of the time-dependent detachment of the polymer component from the support material. Thus, a controlled curing over time of hydratable building material mixtures occurs when using this pulverulent building material composition and a controlled “internal drying” over time of building materials based on aqueous dispersions is also possible.

The following examples illustrate the advantages of the composition of the invention.

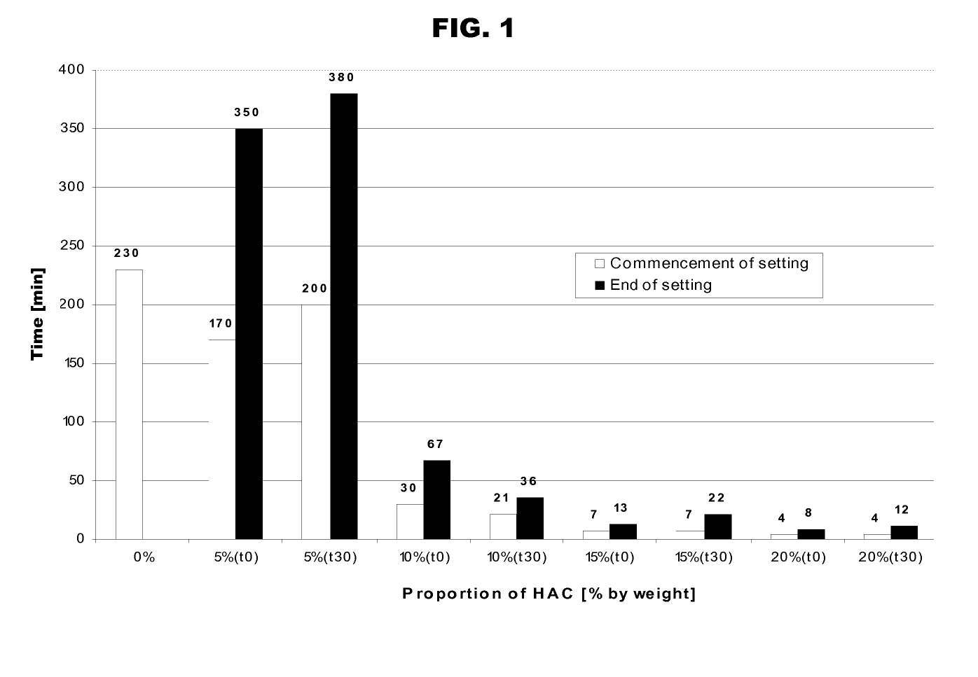

FIGS. 1 to 4 show the setting times of various systems.

FIG. 1: system PC/HAC 1;

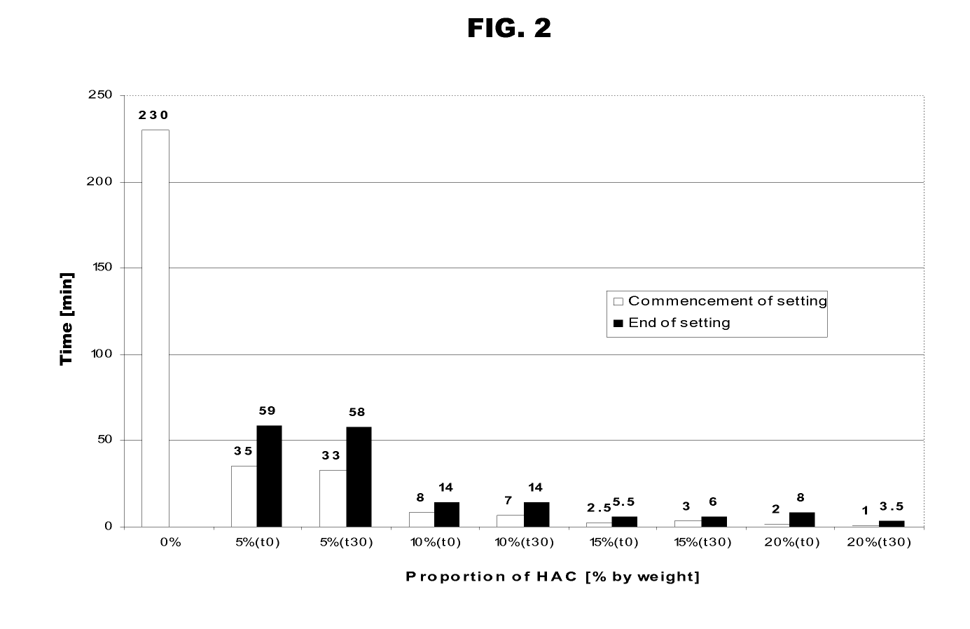

FIG. 2: system PC 1/HAC 2;

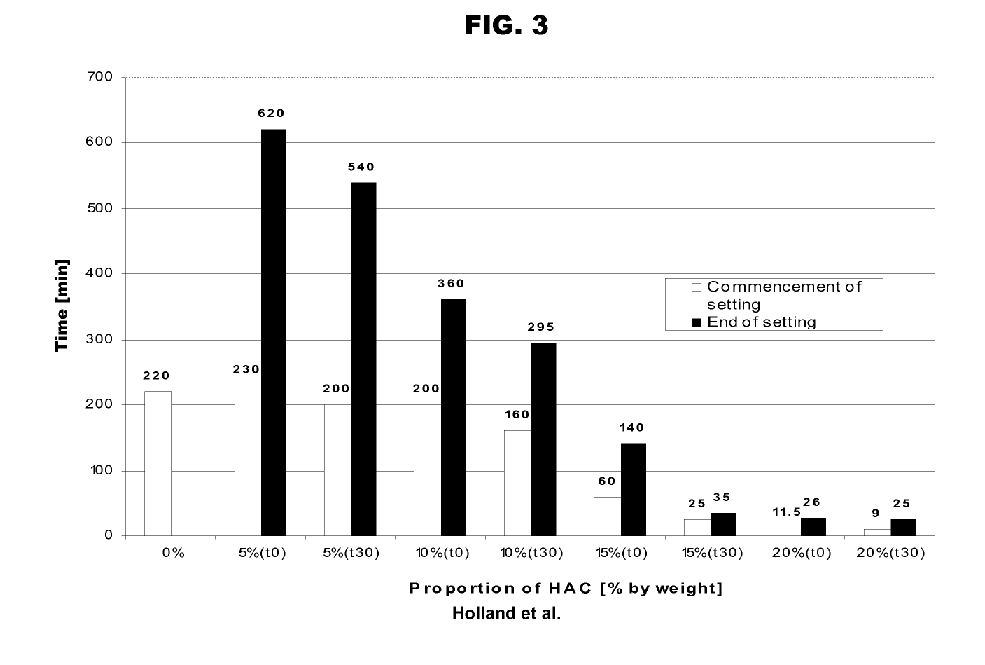

FIG. 3: system PC 2/HAC 1

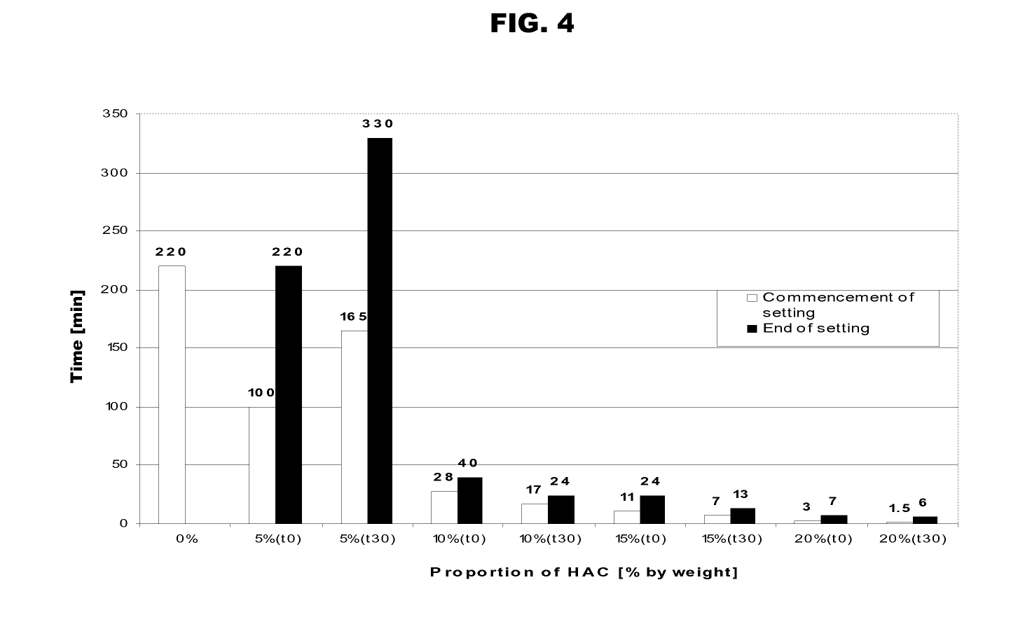

FIG. 4: system PC 2/HAC 2

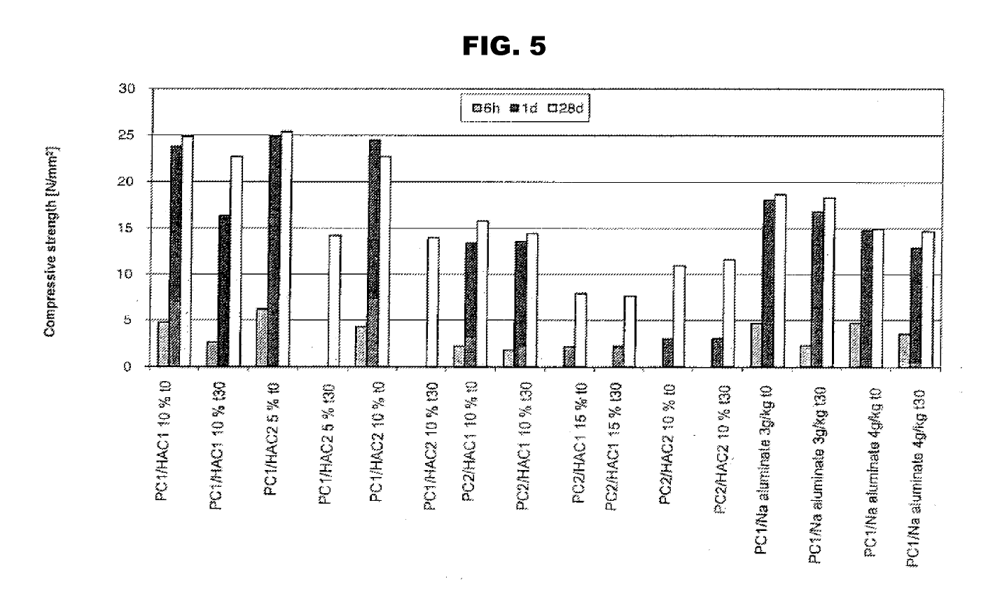

FIG. 5 shows the compressive strength and

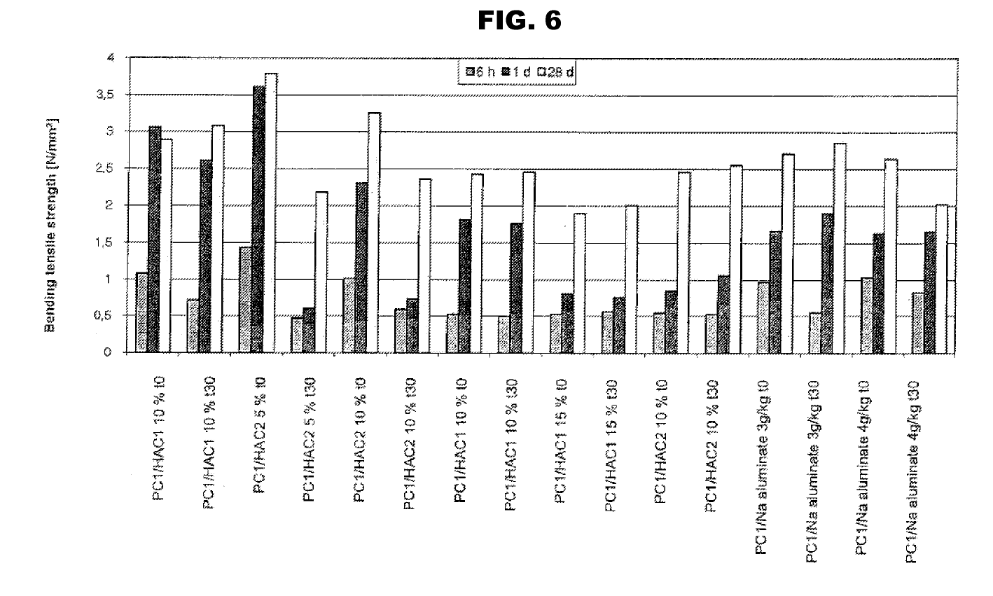

FIG. 6 shows the bending tensile strength of the various systems.

### EXAMPLES

### Comparative Example

The systems examined comprised 60% by weight of sand and 40% by weight of a cement component which in each case was composed of Portland cement (PC) and a high-alumina cement (HAC) with the proportion of the high-alumina cement being varied from 0 to 20% by weight. The high-alumina cement was in each case added 30 minutes after mixing with water (t₃₀). For comparison, each mixture was admixed with the available high-alumina cement during mixing with water (t₀). Prior to mixing with water, the dried powder mixtures were homogeneously mixed, then sprinkled into the water and stirred by means of a Rilem mixer. The mixtures were in each case set to a comparable consistency by mixing with water, for which purpose 1.5 kg in each case of a powder mixture of 900 g of sand and 600 g of cement (PC and HAC) was stirred with the appropriate amount of water (cf. Table 1). For comparative testing of later addition of the high-alumina cement, this was added to the mixture made up with water 30 minutes after this had been made and the resulting mixture was once again homogenized by means of the Rilem mixer.

The commencement of setting and the end of setting were in each case determined as in Examples 2 and 3 by means of a Vicat measuring instrument.

The abbreviations used have the following meanings:

PC 1: Portland cement grade Cem I 42.5 R
PC 2: Portland cement grade Cem I 32.5 R
HAC 1: high-alumina cement (rich in Fe)
HAC 2: high-alumina cement (low in Fe)

TABLE 1
Compositions of the mixtures

| | Proportion | Commencement | End of |
|---|---|---|---|
| | of aluminate | of setting | setting |
| System | component | [min] | [min] |
| PC1/HAC1 | | | |
| | 0% | 230 | |
| 1 | 5% (t₀) | 170 | 350 |
| 2 | 5% (t₃₀) | 200 | 380 |
| 3 | 10% (t₀) | 30 | 67 |
| 4 | 10% (t₃₀) | 21 | 36 |
| 5 | 15% (t₀) | 7 | 13 |
| 6 | 15% (t₃₀) | 7 | 22 |
| 7 | 20% (t₀) | 4 | 8 |
| 8 | 20% (t₃₀) | 4 | 12 |
| PC1/HAC2 | | | |
| | 0% | 230 | |
| 9 | 5% (t₀) | 35 | 59 |
| 10 | 5% (t₃₀) | 33 | 58 |
| 11 | 10% (t₀) | 8 | 14 |
| 12 | 10% (t₃₀) | 7 | 14 |
| 13 | 15% (t₀) | 2.5 | 5.5 |
| 14 | 15% (t₃₀) | 3 | 6 |
| 15 | 20% (t₀) | 2 | 8 |
| 16 | 20% (t₃₀) | 1 | 3.5 |
| PC2/HAC1 | | | |
| | 0% | 220 | |
| 17 | 5% (t₀) | 230 | 620 |
| 18 | 5% (t₃₀) | 200 | 540 |
| 19 | 10% (t₀) | 200 | 360 |
| 20 | 10% (t₃₀) | 160 | 295 |
| 21 | 15% (t₀) | 60 | 140 |
| 22 | 15% (t₃₀) | 25 | 35 |
| 23 | 20% (t₀) | 11.5 | 26 |
| 24 | 20% (t₃₀) | 9 | 25 |
| PC2/HAC2 | | | |
| | 0% | 220 | |
| 25 | 5% (t₀) | 100 | 220 |
| 26 | 5% (t₃₀) | 165 | 330 |
| 27 | 10% (t₀) | 28 | 40 |
| 28 | 10% (t₃₀) | 17 | 24 |
| 29 | 15% (t₀) | 11 | 24 |
| 30 | 15% (t₃₀) | 7 | 13 |
| 31 | 20% (t₀) | 3 | 7 |
| 32 | 20% (t₃₀) | 1.5 | 6 |
| PC1/Na | 3 g/kg (t₀) | 75 | 90 |
| aluminate | 3 g/kg (t₃₀) | 90 | 105 |
| | 4 g/kg (t₀) | 13 | 51 |
| | 4 g/kg (t₃₀) | 56 | 78 |
| | 5 g/kg (t₀) | 0 | 0 |
| | 5 g/kg (t₃₀) | 4.5 | 18.5 |

The action of the HAC as component which accelerates setting which occurs after delayed addition can clearly be seen. As an aspect typical of cement, certain sometimes nonsystematic shifts in the times of commencement of setting and end of setting occur, depending on the content of added HAC.

The associated strengths after 6 h, 1 d, 28 d as shown in Table 2 show that later addition (t₃₀) gives industrially usable strengths which correspond to those resulting from simultaneous mixing with water (t₀).

TABLE 2
Mixtures for examination of the strengths

| | | | Proportion | Amounts | | | | | |
|---|---|---|---|---|---|---|---|---|---|
| | | Cement | of | of | Na | | | W/C | DIN |
| No. | Time | system | HAC | cement | aluminate | Water | Sand | ratio | flow |
| a | 0 min | PC1/ | 10% | 1080 g/120 g | | 529 g | 1800 g | 0.44 | 16.2 cm |
| | | HAC1 | | | | | | | |
| b | 30 min | PC1/ | 10% | 1080 g/120 g | | 529 g | 1800 g | 0.44 | 15.2 cm |
| | | HAC1 | | | | | | | |
| c | 0 min | PC1/ | 5% | 1140 g/60 g | | 535 g | 1800 g | 0.45 | 15.9 cm |
| | | HAC2 | | | | | | | |
| d | 30 min | PC1/ | 5% | 1140 g/60 g | | 535 g | 1800 g | 0.45 | 15.0 cm |
| | | HAC2 | | | | | | | |
| e | 0 min | PC1/ | 10% | 1080 g/120 g | | 642 g | 1800 g | 0.54 | 15.0 cm |
| | | HAC2 | | | | | | | |
| f | 30 min | PC1/ | 10% | 1080 g/120 g | | 642 g | 1800 g | 0.54 | 15.5 cm |
| | | HAC2 | | | | | | | |
| g | 0 min | PC2/ | 10% | 1080 g/120 g | | 549 g | 1800 g | 0.46 | 15.0 cm |
| | | HAC1 | | | | | | | |
| h | 30 min | PC2/ | 10% | 1080 g/120 g | | 549 g | 1800 g | 0.46 | 14.0 cm |
| | | HAC1 | | | | | | | |
| i | 0 min | PC2/ | 15% | 1020 g/120 g | | 552 g | 1800 g | 0.46 | 15.3 cm |
| | | HAC1 | | | | | | | |
| j | 30 min | PC2/ | 15% | 1020 g/180 g | | 552 g | 1800 g | 0.46 | 15.3 cm |
| | | HAC1 | | | | | | | |
| k | 0 min | PC2/ | 10% | 1080 g/120 g | | 592 g | 1800 g | 0.49 | 16.7 cm |
| | | HAC2 | | | | | | | |
| l | 30 min | PC2/ | 10% | 1080 g/120 g | | 592 g | 1800 g | 0.49 | 16.0 cm |
| | | HAC2 | | | | | | | |
| m | 0 min | PC1/Na | 3 g/kg | 1200 g | 9 g | 693 g | 1800 g | 0.58 | 17.2 cm |
| | | aluminate | | | | | | | |
| n | 30 min | PC1/Na | 3 g/kg | 1200 g | 9 g | 693 g | 1800 g | 0.58 | 17.2 cm |
| | | aluminate | | | | | | | |
| o | 0 min | PC1/Na | 4 g/kg | 1200 g | 12 g | 768 g | 1800 g | 0.64 | 16.0 cm |
| | | aluminate | | | | | | | |
| p | 30 min | PC1/Na | 4 g/kg | 1200 g | 12 g | 768 g | 1800 g | 0.64 | 15.2 cm |
| | | aluminate | | | | | | | |

Examples 2 and 3 below demonstrate the effect of the delayed setting-free as a result of a coating according to the invention which dissolves with a delay.

### Example 2

### Coating with Polyvinyl Alcohol

500 g of the mineral components were in each case intimately mixed with 300 g of a polyvinyl alcohol (Mowiol 40-88) and intensively kneaded at 190° C. in a heatable kneading reactor. The cooled composition obtained was comminuted in a coffee mill and sieved through a 1 mm sieve.

The following mineral components were used:

a) white cement
b) high-alumina cement 1 (HAC 1=rich in Fe)
c) high-alumina cement 2 (HAC 2=low in Fe)

The alkaline reaction of white cement in water was exploited to test the quality of the coating in a simple preliminary test. For this purpose, 3 g of the respective coated material are sprinkled into 100 ml of water having a pH of 7 and additionally containing a few drops of phenolphthalein solution. The time until the phenolphthalein changes from colorless to red is measured:

| | Time to color | |
|---|---|---|
| | change | |
| Experiment | [min] | Activator |
| White cement | immediate | none |
| (uncoated) | | |
| Example 2a) | >10 | borax |
| Example 2a) | >40 | none |

### Example 33

### Coating with Liquid Components

20 kg of the mineral component (=reactive support material) were in each case sprayed with x l of the coating liquid with the aid of a spray nozzle in a Lödige mixer at 40 rpm, cutter setting 1. A largely free-flowing, slightly lumpy material was obtained, and this was sieved through a 1 mm sieve.

| | Reactive | | Amount of |
|---|---|---|---|
| | support | | coating |
| Example 3 | material | Coating material | material [l] |
| a) | white | Dynasilan F 8800 | 9 |
| | cement | | |
| b) | HAC1 | Dynasilan F 8800 | 11 |
| c) | HAC2 | Dynasilan F 8800 | 11 |
| d) | white | Dynasilan F 8261 | 11 |
| | cement | | |
| e) | HAC1 | Dynasilan F 8261 | 14 |
| f) | HAC2 | Dynasilan F 8261 | 14 |
| g) | white | FC-4432 | 15 |
| | cement | | |
| h) | HAC1 | FC-4432 | 15 |
| i) | HAC2 | FC-4432 | 15 |

The alkaline reaction of white cement in water was exploited to test the quality of the coating in a simple preliminary test. For this purpose, 3 g of the respective coated material are sprinkled into 100 ml of water having a pH of 7 and additionally containing a few drops of phenolphthalein solution. The time until the phenolphthalein changes from colorless to red is measured:

| | Time to color | |
|---|---|---|
| | change | |
| Experiment | [min] | Activator |
| White cement | immediate | none |
| (uncoated) | | |
| Example 3a) | >10 | none |
| Example 3d) | >10 | none |
| Example 3g) | >10 | none |

To test the action in a mortar system, the identical mixtures as set forth in Table 2 with coated HAC were used and the corresponding setting times were measured:

| | | Commencement | |
|---|---|---|---|
| | | of | End of |
| | | setting | setting |
| System | Proportion of HAC | [min] | [min] |
| PC1/HAC1 | 10% of HAC1 Ex. 3b) | 30 | 90 |
| | 10% of HAC1 Ex. 3e) | 50 | 150 |
| | 10% of HAC1 Ex. 3h) | 35 | 105 |
| PC1/HAC2 | 10% of HAC2 Ex. 3c) | 15 | 25 |
| | 10% of HAC2 Ex. 3f) | 25 | 60 |
| | 10% of HAC2 Ex. 3i) | 12 | 30 |
| PC2/HAC2 | 15% of HAC1 Ex. 3b) | 40 | 70 |
| | 15% of HAC1 Ex. 3e) | 60 | 110 |
| | 15% of HAC1 Ex. 3h) | 43 | 85 |
| PC2/HAC1 | 10% of HAC2 Ex. 3c) | 20 | 50 |
| | 10% of HAC2 Ex. 3f) | 35 | 90 |
| | 10% of HAC2 Ex. 3i) | 18 | 45 |

1-13. (canceled)

14. A method for controlled curing over time of hydratable building materials, comprising the steps of:
applying a pulverulent building material composition having a delayed action, the composition comprising (a) a reactive support material and (b) a liquid polymer compound applied to the support material; and
providing detachment of the polymer compound from the support material by mechanical action and/or by action of a solvent.

15. The method according to claim 14, wherein the detachment is provided by mixing of the building material mixture with water.

16. The method according to claim 15, comprising adding an activator before, during and/or after mixing of the building material mixture with water to improve detachment.

17. The method according to claim 16, wherein the activator is selected from the group consisting of borates.

18. The method according to claim 16, wherein the activator is added in liquid form.

19. The method according to claim 16, wherein the activator is added as a powder.

20. The method according to claim 16, wherein the activator is added on a support material.

21. The method according to claim 16, wherein the activator is in an amount of from 0.01 to 50% by weight, based on the amount of support material.

22. The method according to claim 14, wherein the polymer compound is selected from the group consisting of polyvinyl alcohols, polyvinyl acetates, polymers based on AMPS, modified or unmodified biopolymers such as xanthans, carregeenins, cellulose ethers and starch ethers, silanes, polyethylene glycols and waxes.

23. The method according to claim 14, wherein the support material has a mean particle size from 0.001 μm to 1 cm.

24. A pulverulent building material composition having a delayed action, comprising
a) a reactive support material; and
b) a liquid polymer compound applied to the support material.

25. The composition as claimed in claim 14, wherein the polymer compound is selected from the group consisting of polyvinyl alcohols, polyvinyl acetates, polymers based on AMPS, modified or unmodified biopolymers such as xanthans, carregeenins, cellulose ethers and starch ethers, silanes, polyethylene glycols and waxes.

26. The composition as claimed in claim 14, wherein the support material has a mean particle size of from 0.001 μm to 1 cm.
